(19) United States
(12) Patent Application Publication
(10) Pub. No.: US 2010/0103164 A1
(43) Pub. Date: Apr. 29, 2010

(54) Apparatus and method of processing three dimensional graphic data using texture factor

(75) Inventors: Sang Oak Woo, Anyang-si (KR); Seok Yoon Jung, Seoul (KR); Kwon Taek Kwon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/385,414

(22) Filed: Apr. 7, 2009

(30) Foreign Application Priority Data
Oct. 28, 2008 (KR) 10-2008-0105812

(51) Int. Cl. G06T 15/00; G09G 5/00

(52) U.S. Cl. 345/419; 345/582

(57) ABSTRACT

A method and apparatus of processing three-dimensional (3D) graphic data using a texture factor. The method of processing 3D graphic data includes configuring a polygon including a plurality of vertexes, calculating a texture factor of an object texture corresponding to the polygon, the texture factor being associated with a degree by which the object texture is identified on an actual screen, and determining a texture filtering mode with respect to the object texture based on the calculated texture factor.

### CROSS-REFERENCE TO RELATED APPLICATIONS

This application claims the benefit of Korean Patent Application No. 10-2008-0105812, filed on Oct. 28, 2008, in the Korean Intellectual Property Office, the disclosure of which is incorporated herein by reference.

### BACKGROUND

1. Field

Example embodiments relate to a technique for processing three-dimensional (3D) graphic data, and more particularly, to a technique for performing texture filtering.

2. Description of the Related Art

Processing three-dimensional (3D) graphic data may include converting coordinates of vertexes included in a polygon as necessary, assigning material properties to the vertexes, and applying a fog effect or a lighting effect, and may also include a texture mapping process of mapping, in the polygon, textures previously stored in a memory.

However, to process the 3D graphic data, many resources such as a large quantity of computation and a large number of memory accesses may be required. As a result, it is difficult for devices with a relatively low processing ability to sufficiently process the 3D graphic data. In particular, a texture filtering process of acquiring a color value for pixels of a screen from the textures included in the texture mapping process may need the large number of memory accesses.

Therefore, there is a need for reducing resources required in processing the above-mentioned 3D graphic data.

### SUMMARY

Example embodiments may provide a method and apparatus of processing three-dimensional (3D) graphic data, in which a texture filtering mode may be adaptively determined depending on a texture factor, thereby reducing resources required in processing the 3D graphic data.

Example embodiments may also provide a method and apparatus of processing 3D graphic data, in which a texture filtering mode may be determined so that an amount of information provided from a memory is appropriately adjusted depending on a degree (texture factor) by which a texture is identified on an actual screen.

Example embodiments may also provide a method and apparatus of processing 3D graphic data, in which a mipmap level may be adaptively determined depending on the texture factor, thereby reducing information unnecessarily provided from the memory, and unnecessary memory accesses.

According to example embodiments, there may be provided a method of processing 3D graphic data, the method including: configuring a polygon including a plurality of vertexes; calculating a texture factor of an object texture corresponding to the polygon, the texture factor being associated with a degree by which the object texture is identified on an actual screen; and determining a texture filtering mode with respect to the object texture based on the calculated texture factor.

According to example embodiments, there may be also provided an apparatus of processing 3D graphic data, the apparatus including: a polygon configuring module to configure a polygon including a plurality of vertexes; a calculation module to calculate a texture factor of an object texture corresponding to the polygon, the texture factor being associated with a degree by which the object texture is identified on an actual screen; a mode determination module to determine a texture filtering mode with respect to the object texture based on the calculated texture factor; and a filtering module to perform a texture filtering based on the determined texture filtering mode.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of example embodiments will become apparent and more readily appreciated from the following description, taken in conjunction with the accompanying drawings of which:

FIG. 1 is a computer generated image illustrating an example in which mapped textures are not well identified due to application of fog effect;

FIG. 2 is a computer generated image illustrating an example in which mapped textures are not well identified due to application of lighting effect;

FIG. 3 is a block diagram illustrating an apparatus of processing three-dimensional (3D) graphic data according to example embodiments;

FIG. 4 is a diagram illustrating a texture factor table and mode table according to example embodiments; and

FIG. 5 is an operational flowchart illustrating a method of processing 3D graphic data according to example embodiments.

### DETAILED DESCRIPTION OF EMBODIMENTS

Reference will now be made in detail to example embodiments, examples of which are illustrated in the accompanying drawings, wherein like reference numerals refer to the like elements throughout. Example embodiments are described below to explain the present disclosure by referring to the figures.

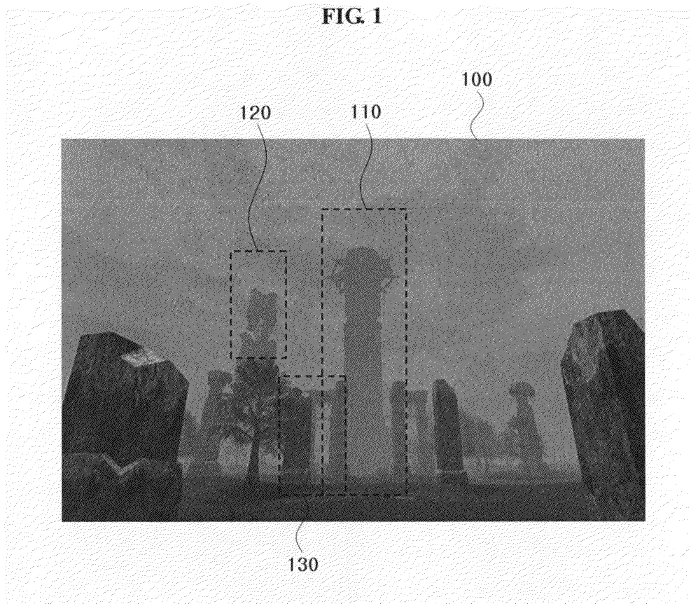

FIG. 1 is a computer generated image illustrating an example in which mapped textures are not well identified due to application of a fog effect.

Referring to FIG. 1, a screen 100 of a display may include various objects. In FIG. 1, objects in the distance may be viewed as being significantly blurry due to the fog effect. Here, the fog effect may designate a technique for enabling the objects in the distance to be viewed indistinctly so as to increase a sense of reality of three-dimensional (3D) graphic data. For example, as a distance to the object from a view point of a 3D graphic (for example, a camera) is increased, the fog effect may be significantly applied to the object.

Specifically, the fog effect may be significantly applied to the objects 110 and 120 since a distance to objects 110 and 120 from the view point of the 3D graphic is relatively large, and insignificantly applied to an object 130.

In this instance, when the distance to the object from the view point is larger than a predetermined distance, an original color and texture of the object may not be well identified due to the fog effect. Specifically, a color and texture of a specific object may not be well identified when a strength of the fog effect applied in the specific object is greater than a specific level.

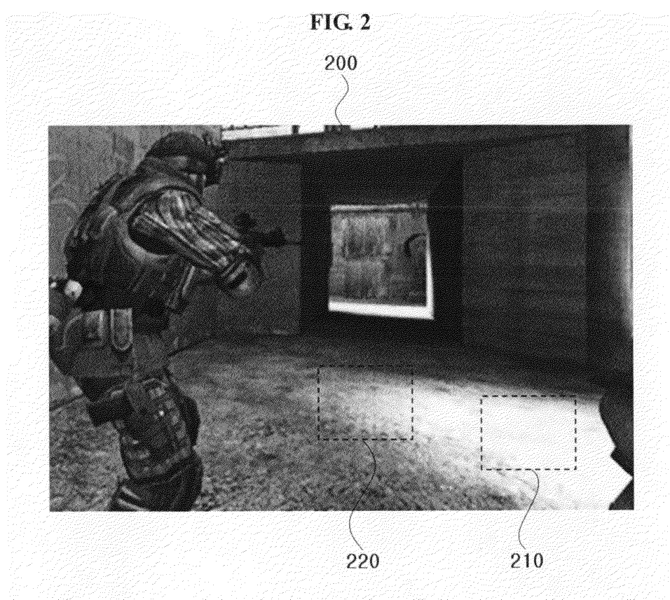

FIG. 2 is a computer generated image illustrating an example in which mapped textures are not well identified due to application of a lighting effect.

Referring to FIG. 2, a lighting effect may be applied to a part of a screen 200 of a display. Specifically, the lighting effect may be significantly applied to a segment 210, so that a user has a difficulty in identifying a texture mapped in the segment 210. Also, the lighting effect may be minimally applied to a segment 220, so that the texture mapped in the segment 220 is indistinctly identified.

Consequently, referring to FIGS. 1 and 2, the mapped texture may be indistinctly identified due to the fog effect and lighting effect. Also, although not shown in FIGS. 1 and 2, the mapped texture may not be well identified even when effects incurred by dark adaptation/light adaptation are applied. When a user moves from a relatively bright place to a relatively dark place, eyes of the user may undergo dark adaptation. Conversely, when the user moves from the relatively dark place to the relatively bright place, the eyes of the user may undergo light adaptation. Here, applying ‘dark adaptation/light adaptation effects’ may designate performing 3D graphic processing based on the dark adaptation/light adaptation.

In this instance, the method and apparatus of processing 3D graphic data according to an embodiment may use a texture factor, that is, an indicator indicating a degree by which textures are identified in an actual screen.

Here, it is assumed that the texture is more distinctly identified in the actual screen along with an increase in the texture factor. Performing precise texture mapping with respect to a texture corresponding to a relatively low texture factor may be an unnecessary task. Specifically, performing precise texture mapping with respect to textures unidentified in the actual screen may incur an increase in a number of unnecessary memory accesses. Accordingly, an amount of information required in textures for the texture mapping may be required to be appropriately adjusted based on the degree by which the textures are identified in the actual screen.

In this instance, the method and apparatus of processing 3D graphic data according to an exemplary embodiment may appropriately adjust the amount of information required in the texture based on the texture factor. For example, the method and apparatus of processing 3D graphic data may perform texture filtering (or texture mapping) with respect to textures corresponding to a relatively low texture factor using a smaller amount of texture information, thereby reducing a number of memory accesses and a bandwidth of data transmitted from a memory. Because the textures corresponding to the relatively low texture factor are indistinctly identified in the actual screen, using a large amount of texture information may be a waste.

In particular, the method and apparatus of processing 3D graphic data may appropriately adjust a mipmap level when using mipmap filtering method for the texture mapping, thereby appropriately adjusting the amount of information required in the texture. Here, the mipmap filtering method may be a method using a plurality of textures with respect to an identical image for the purpose of the texture filtering. In the mipmap filtering method, the plurality of textures may have a relatively low resolution in a gradual manner, and also a height and width of each of the textures may be reduced in a gradual manner. The ‘mipmap level’ used throughout the specification may correspond to a number of the plurality of textures with respect to the identical image.

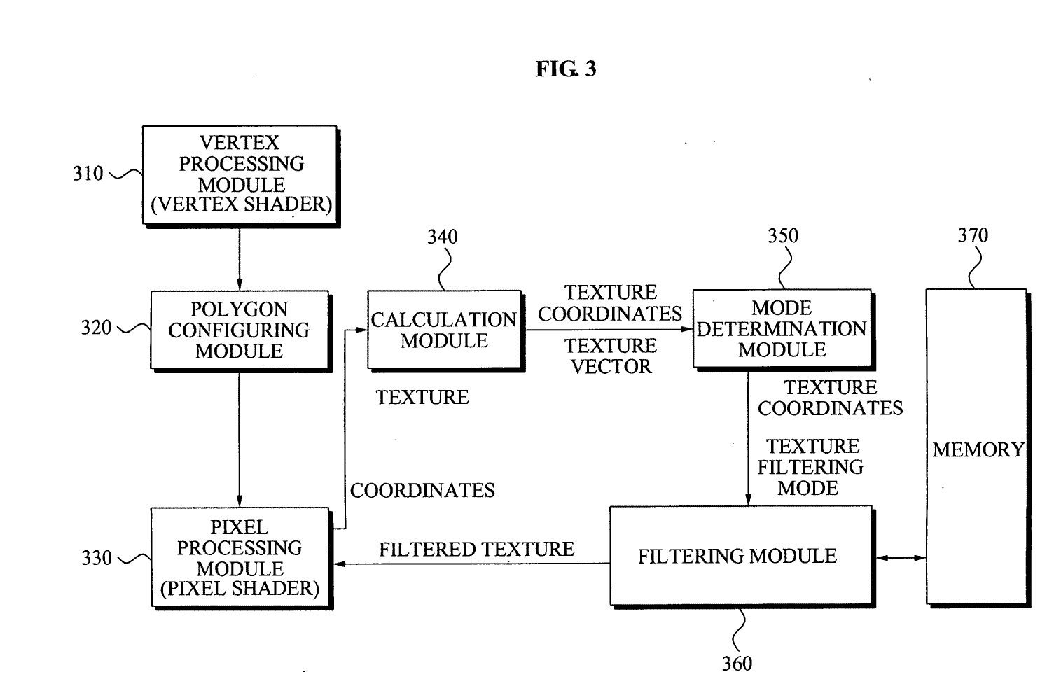

FIG. 3 is a block diagram illustrating an apparatus of processing three-dimensional (3D) graphic data according to example embodiments. In an example, the apparatus may include a processor to process the 3D graphic data and a display to display the 3D graphic data according to example embodiments.

Referring to FIG. 3, the apparatus of processing 3D graphic data according to the present embodiment may include a vertex processing module 310, a polygon configuring module 320, a pixel processing module 330, a calculation module 340, a mode determination module 350, and a filtering module 360.

The vertex processing module 310 (vertex shader) may convert coordinates of vertexes, as necessary, and assign material properties to each of the vertexes. Also, the vertex processing module 310 may apply the fog effect and lighting effect to each of the vertexes.

Also, the polygon configuring module 320 may configure polygons including a plurality of vertexes. Here, as a representative example of the polygon, a triangle may be given. In this instance, in each of the generated polygons, a corresponding texture may be mapped.

Also, the pixel processing module 330 may determine each value of pixels included in each of the polygons (for example, red (R), green (G), blue (B), and a transparency (A)). Also, the pixel processing module 330 may perform pixel processing using information (texture information) concerning a texture corresponding to each of the polygons. In this instance, the pixel processing module 330 may generate texture coordinates so as to obtain the texture information corresponding to each of the polygons.

However, although described in detail below, the texture information may be read from a memory 370 in response to a texture filtering mode adaptively determined according to the texture factor.

Also, the calculation module 340 may calculate a texture factor of a texture corresponding to the texture coordinates. Here, the texture factor as described above may be an indicator indicating how much the texture is well identified in the actual screen. For example, the texture factor may be calculated considering a depth of a pixel corresponding to the texture, the fog effect and lighting effect applied to the pixel, and the like. In addition, R, G, B, and A values of an adjacent pixel, the fog effect and lighting effect applied to the adjacent pixel, and the like may be further considered.

Also, a graphic user may design a program for flexibly calculating the texture factor. Specifically, the program for calculating the texture factor may be changed so as to consider various factors, as necessary. For example, a user may design a program focusing on the fog effect, and another user may design a program focusing on the lighting effect.

Also, the mode determination module 350 may determine a texture filtering mode based on a texture factor of a texture corresponding to a pixel. In this instance, the mode determination module 350 may previously prepare a plurality of modes such as a nearest point sampling mode, a linear filtering mode, a mipmap filtering mode, an anisotropic filtering mode, a non-filtering mode, and the like. Also, any one of the previously prepared plurality of modes may be determined as the texture filtering mode according to the calculated texture factor.

The mode determination module 350 may adaptively determine the texture filtering mode to enable an amount of information required in a texture to be adjusted depending on the texture factor. For example, when the texture factor is significantly low (specifically, when the texture is barely identifiable in the actual screen), the mode determination module 350 may select the nearest point sampling mode, thereby reducing an amount of information concerning the texture transmitted from the memory 370. Specifically, the texture filtering mode may be determined so that the amount of information required in the texture depending on the texture factor may be adaptively increased or reduced.

Also, the mode determination module 350 may adaptively adjust a mipmap level depending on the texture factor when performing mipmap filtering. For example, the mode determination module 350 may determine the texture filtering mode so as to enable mipmap filtering having a relatively high resolution (relatively high mipmap level) to be performed when the texture factor is relatively high. By contrast, the mode determination module 350 may select a mipmap filtering mode having a relatively low mipmap level, when the texture factor is relatively low.

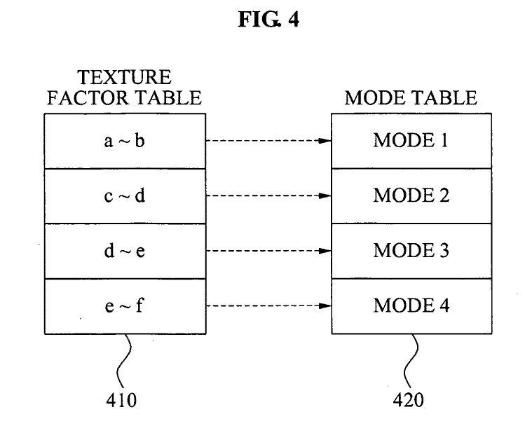

Also, the mode determination module 350 may compare at least one threshold value prepared in advance so as to reduce computation quantity with the calculated texture factor, thereby easily determining the texture filtering mode. This will be described in detail with reference to FIG. 4.

Also, the filtering module 360 may perform texture filtering depending on the determined texture filtering mode. In this instance, the filtering module 360 may perform the texture filtering according to any one of the nearest point sampling mode, the linear filtering mode, the mipmap filtering mode, the anisotropic filtering mode, and the non-filtering mode. Consequently, the filtering module 360 may read information concerning the texture from the memory 370 based on the determined texture filtering mode.

Accordingly, the apparatus of processing 3D graphic data according to an embodiment may determine an appropriate texture filtering mode when a large amount of information concerning the texture is not needed, thereby reducing unnecessary memory accesses and also reducing a bandwidth of data.

FIG. 4 is a diagram illustrating a texture factor table and mode table according to example embodiments.

Referring to FIG. 4, a texture factor table 410 may store previously determined threshold values (a, b, c, d, e, and f), and a mode table 420 may prepare a plurality of modes 1, 2, 3, and 4 being available as the texture filtering mode.

In this instance, the method and apparatus of processing 3D graphic data may compare the calculated texture factor and the previously determined threshold values. Also, a mode corresponding to the calculated texture factor may be selected as the texture filtering mode depending on the calculated texture factor. For example, when the calculated texture factor is involved in a range of a to b, the mode 1 may be determined as the texture filtering mode.

Accordingly, the method and apparatus of processing 3D graphic data according to an embodiment may adaptively determine the texture filtering mode using a simple comparison operation.

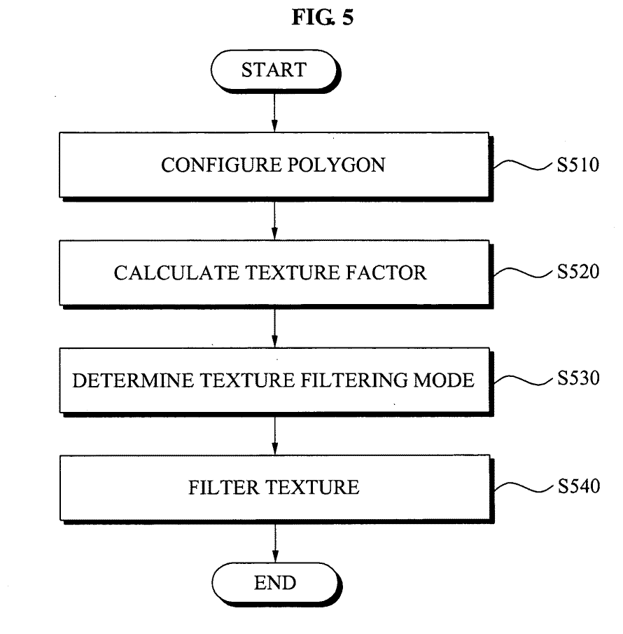

FIG. 5 is an operation flowchart illustrating a method of processing 3D graphic data according to example embodiments.

Referring to FIG. 5, in operation S510, the method of processing 3D graphic data according to the present embodiment may configure a polygon including a plurality of vertexes.

In this instance, operation S510 for determining the texture filtering mode may be an operation for determining the texture filtering mode so that an amount of information required in the object texture is adjusted depending on the calculated texture factor. Particularly, operation S51 0 for determining the texture filtering mode may be an operation for determining the texture filtering mode so that a mipmap level applied in performing mipmap filtering is adjusted depending on the calculated texture factor.

Also, in operation S520, the method of processing 3D graphic data according to the present embodiment may calculate a texture factor of the object texture corresponding to the polygon.

Also, in operation S530, the method of processing 3D graphic data according to the present embodiment may determine a texture filtering mode with respect to the object texture depending on the calculated texture factor.

Also, in operation S540, the method of processing 3D graphic data according to the present embodiment may perform texture filtering depending on the determined texture filtering mode.

Corresponding descriptions in FIGS. 1 to 4 may be applied to operations which are not described in detail although illustrated in FIG. 5, and thus detailed descriptions of the operations will be herein omitted.

The method of processing 3D graphic data according to the above-described example embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. The method of processing 3D graphic data according to the above-described example embodiments may be implemented in computing hardware (computing apparatus) and/or software, such as (in a non-limiting example) any computer that can store, retrieve, process and/or output data and/or communicate with other computers. The results produced can be displayed on a display of the computing hardware.

Further, according to an aspect of the embodiments, any combinations of the described features, functions and/or operations can be provided.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

What is claimed is:

1. A method of processing three dimensional (3D) graphic data by a processor, the method comprising:
configuring a polygon including a plurality of vertexes;
calculating a texture factor of an object texture corresponding to the polygon, the texture factor being associated with a degree by which the object texture is identified on an actual screen; and
determining a texture filtering mode with respect to the object texture based on the calculated texture factor.

2. The method of claim 1, wherein the determining determines the texture filtering mode so that an amount of information required with respect to the object texture is adjusted based on the calculated texture factor.

3. The method of claim 1, wherein the determining determines the texture filtering mode so that a mipmap level applied in performing a mipmap filtering is adjusted based on the calculated texture factor.

4. The method of claim 1, wherein the determining reduces the mipmap level along with a reduction in the degree by which the object texture is identified on the actual screen, or increases along with an increase in the degree by which the object texture is identified on the actual screen.

5. The method of claim 1, wherein the determining reduces the amount of information required with respect to the object texture along with a reduction in the degree by which the object texture is identified on the actual screen, or increases the amount of information required with respect to the object texture along with an increase the degree by which the object texture is identified on the actual screen.

6. The method of claim 1, wherein the determining compares at least one predetermined threshold value and the texture factor, and determines, as the texture filtering mode, at least one from among a predefined plurality of modes based on a compared result.

7. The method of claim 1, wherein the predefined plurality of modes include at least two of a nearest point sampling mode, a linear filtering mode, a mipmap filtering mode, an anisotropic filtering mode, and a non-filtering mode.

8. The method of claim 1, further comprising:
performing a texture filtering based on the determined texture filtering mode.

9. The method of claim 1, wherein the calculating calculates the texture factor based on at least one of fog effect, lighting effect, and dark adaptation/bright adaptation effects, each of the effects being applied in the object texture.

10. At least one medium comprising computer readable instructions implementing the method of claim 1.

11. An apparatus of processing 3D graphic data, the apparatus comprising:
a polygon configuring module to configure a polygon including a plurality of vertexes;
a calculation module to calculate a texture factor of an object texture corresponding to the polygon, the texture factor being associated with a degree by which the object texture is identified on an actual screen; and
a mode determination module to determine a texture filtering mode with respect to the object texture based on the calculated texture factor.

12. The apparatus of claim 11, further comprising:
a filtering module to perform a texture filtering based on the determined texture filtering mode.

13. The apparatus of claim 11, wherein the mode determination module determines the texture filtering mode so that an amount of information required with respect to the object texture is adjusted based on the calculated texture factor.

14. The apparatus of claim 11, wherein the mode determination module determines the texture filtering mode so that a mipmap level applied in performing a mipmap filtering is adjusted based on the calculated texture factor.

15. The apparatus of claim 11, wherein the mode determination mode compares at least one predetermined threshold value and the texture factor, and determines, as the texture filtering mode, at least one from among a predefined plurality of modes based on a compared result.

16. The apparatus of claim 15, wherein the plurality of modes include at least two of a nearest point sampling mode, a linear filtering mode, a mipmap filtering mode, an anisotropic filtering mode, and a non-filtering mode.

17. The apparatus of claim 11, wherein the calculation module calculates the texture factor based on at least one of fog effect, lighting effect, and dark adaptation/bright adaptation effects, each of the effects being applied in the object texture.
